(19) United States
(12) Patent Application Publication
(10) Pub. No.: US 2006/0157539 A1
(43) Pub. Date: Jul. 20, 2006

(54) Hot reduced coil tubing

(76) Inventor: Jon David DuBois, Freeport, TX (US)

Correspondence Address: Alan H. Gordon;Alan H. Gordon & Associates, P.C., Suite 405, 3262 Westheimer Road, Houston, TX, 77098-1002, US

(21) Appl. No.: 11/038,611

(22) Filed: Jan. 19, 2005

(51) Int. Cl. B23K 31/02; B21D 39/00

(52) U.S. Cl. 228/144; 228/103

(57) ABSTRACT

Continuous coil tubing made from shorter lengths of flat metal strip which are spliced end-to-end and formed into tubular form and seam welded and thereafter introduced into a forging or hot reduction process. Finished coil tubing is withdrawn from the process at a different rate than flat metal strip is fed into the process. Welds made to the flat metal strip blend into and substantially disappear from the finished coil tubing.

### RELATED APPLICATION

There are no related applications.

### BACKGROUND OF THE INVENTION

I. Field of the Invention

This invention relates generally to oilfield coilable metallic tubing for use in wellbores, tubular strings, pipelines, bores, boreholes, and other oilfield applications.

II. Description of Related Art

Coil tubing (“CT”) is typically a relatively long continuous length of tubing that can be run in and out of a wellbore, tubular string, pipeline, bore and boreholes. CT is widely used in the oil and gas industry for drilling, completion, production, and workover operations. In addition, CT may be used for control lines, umbilicals, and in other applications requiring relatively long and durable tubing. CT is commonly manufactured from steel or steel alloy. Accessories or tools may be affixed interior to, exterior to, or at the end of, a length of CT to assist in its use or enhance its utility. Such tools and accessories include nozzles, sensors, guides, drill bits, centralizers, pumps, motors, subs, valves and the like. CT may be coated interiorly or exteriorly with a variety of materials. Such coating materials include plastic compositions, composites of plastics and metal, rubberized composites, lubricants, known anti-corrosion treatments and the like. When not in use, CT typically is stored on a spool or reel in various lengths up to, and exceeding, 20,000 feet. When used, the CT is pulled or uncoiled from a storage reel, straightened, supported and urged forward by an injector that positions the CT at a desired location. When it is desired to remove the CT from the initially desired location, the CT is withdrawn and again coiled onto a storage reel. When it is desired to position the CT at a later time, the process is repeated. This repeated coiling and uncoiling introduces stresses into the CT and weakens it to the forces of handling and to the forces from the pressure of fluids passing through it. Because of the stresses imposed on the CT by repeated coiling and uncoiling, by pressure cycles, by tension and torque, and by other forces, lengths of CT are limited to a specified number of duty cycles to minimize the likelihood of a failure. The number of duty cycles that may be tolerated has been predicted on the basis of theoretical and empirical data. Notwithstanding, failures still sometimes occur. The causes of these failures includes defects in welding. These CT failures can result in expensive delays and recovery operations.

It is typical for lengths of CT to have a constant outside diameter (“OD”) that designates the CT's nominal or target size. For example, CT may be delivered in the following OD sizes: 1.0″, 1.25″, 1.5″, 1.75″, 2.0″, 2⅜″, 2⅝″, 2⅞″, 3.5″, 4.0″, 4.5″. When CT is specified, it sometimes is specified in terms of both the OD and wall thickness. The wall thickness of CT may be constant or may vary along its length as described in U.S. Pat. No. 4,629,218 in the name of the same inventor as the present invention. CT with a varying wall thickness is sometimes known as “tapered tubing” and has some advantages that reduce the likelihood of failure.

Coiled tubing is manufactured by processes described in U.S. Pat. Nos. 4,863,091 and 5,191,911, both in the name of the same inventor as the present invention. Among these now known processes for manufacturing CT, one example is a process where rolls of sheet steel, known as master coils typically 4′ to 6′ wide and 1,000 to 3,500′ long, are sliced or slit into strips. These strips are of a width necessary to make the particular CT having a target nominal OD size. Ordinarily, the width of the strip corresponds to the circumference, and hence relates to the OD of, the CT. In some instances the slicing of master coils into slits results in waste where the particular dimensions of the circumference of the CT to be manufactured does not evenly divide into the width of the master coil. That is, there sometimes is a leftover strip not as wide as the others that is not usable. Furthermore, sometimes the edges of the master coil are damaged or of a slightly different chemistry or have slightly different physical characteristics from the interior portions of the master coil. This may result in there being less desirable “end cuts” of the master coil that may not be entirely suitable for high quality CT manufacture. The thickness of the strips cut from the master coil may be constant or may vary gradually along the length of the strip in accordance with the teachings of U.S. Pat. No. 4,629,218 in the name of the same inventor as the present invention. Tapered tubing may be manufactured from flat stock whose thickness varies (usually by continuously increasing or decreasing) over its length. Tapered flat stock is a relatively expensive raw material from which to manufacture CT, and there is relatively limited availability of thicknesses of such tapered flat stock.

Prior to being fashioned into continuous CT, it has been common to join strips of flat feed stock by a transverse weld. The trailing end of a first feed coil may be joined to the leading end of a second feed coil by butt (90°) or bias (off-90°) welding. In bias welding as described in U.S. Pat. Nos. 4,863,091 and 5,191,911, both in the name of the same inventor as the present invention, an angle other than 90° is used between the strips being joined, and some advantages are realized that reduce the likelihood of failure of CT manufactured in accordance with those teachings.

It is contemplated in the prior art that bias weld joints be made by stopping the trailing end of a first feed coil during a period of time when upstream portions such as the leading end and center section of the flat stock of that same coil continue to be processed in a tube forming operation. Through the use of an accumulator, the trailing end of a first feed coil may be stopped for a period of time long enough to achieve a joining of that trailing end to the leading end of a second feed coil, all while the upstream portion of the first feed coil is continuing to be formed into tubing. Because of the relatively long time required to dress the transverse weld and the relatively short period of time available from the use of conventional accumulators, it has been common in the prior art to first transversely weld together all the lengths of flat stock intended to be formed into continuous CT, wind the welded-together flat stock onto a single, relatively large feed coil, and then commence tube manufacture. In this fashion, there is a continuous feeding of the flat stock into the tube mill from a single feed coil without any interruption.

Tubing formation may take place in a tube mill through a series of sub-processes in which the flat feed stock is formed into the shape of tubing. The configuring of the flat stock into tubing usually occurs through a series of rollers that gradually urge the flat stock into an appropriate geometry. The side edges of the flat stock are urged together to achieve a substantially circular cross-section and are welded together. This welding together of the side edges of the flat feed stock forms a longitudinal seam weld along the entire length of the CT. The longitudinal weld may be achieved through a variety of known processes. Electric resistance welding (“ERW”) has been used in the past with some success. When ERW is used, it is known to reach inside the coil tubing being formed and to scarf away or remove the internal longitudinal weld flash. Similarly, it is known to remove the external longitudinal weld flash. It has been the practice in the prior art to anneal the longitudinal weld by subjecting it to localized heating. In the case of relatively small diameter CT with a relatively large wall thickness, the flat stock used to form the coil tubing in process is subjected to forces tending to twist the tubing about its longitudinal axis. If the longitudinal weld is made, say, along the top of the coil tubing in process, then sometimes the small diameter, thick walled tubing will twist such that the longitudinal weld is displaced to one side or the other in relation to the top. Where the seam annealing step of the prior art is carried out by the application of a relatively narrow zone of heat, the actual longitudinal weld might be twisted to the side and be positioned too remote from the zone of heat to be annealed to the extent contemplated. This can result in weakened portions of the longitudinal weld of the CT that are more vulnerable to corrosion, failure from repeated coiling and uncoiling or from other duty cycles where the CT is, say, pressurized.

Following tubing formation, the CT is subjected to heat treating and cooling. Following cooling the CT is spooled onto a takeup reel. The CT may comprise as many lengths of flat feed stock as are welded together and fed through the tube mill. The CT will have a wall thickness that is the same as the thickness of the feed stock that is fed into the tube forming process. As noted, this thickness may be constant or, alternatively, may vary to create tapered tubing.

Although the prior art has produced CT that is generally satisfactory, room for improvement exists. The feed stock has a chemical and physical profile such that the strength and performance characteristics of the CT formed from the flat stock is known. Degradations or departures from the chemical and physical profile of the CT made from the feed stock may occur at the transverse weld of one length of feed stock to another, or continuously along the length of the CT in the region of the longitudinal weld. The stresses introduced by repeated coiling and uncoiling of CT and from the forces imposed by injection and withdrawal of CT from wellbores, exacerbates the consequences of this condition. Although heat treating and bias weld techniques have improved the quality of continuous CT, failures still have occurred in CT, especially along the longitudinal weld and at the transverse weld.

### SUMMARY OF THE PRESENT INVENTION

The present invention undertakes to further improve the quality, reliability, and resistance to coiling and uncoiling stresses of relatively long lengths of CT and to improve the speed and efficiency of the manufacture of CT. The present invention utilizes widths of feed stock that are deliberately selected to be in excess of the circumference, and hence the OD, of CT produced according to the prior art. The present invention may utilize thicknesses of feed stock that are deliberately selected to be in excess of the wall thickness of the CT produced in accordance with the prior art. In the manufacturing process of CT according to the present invention, master coils may be slit into strips having wider widths and/or greater thicknesses than in the prior art. This results in less waste of the steel from the master coil and further facilitates the use of the end cuts to produce higher quality CT. In addition, because the wall thickness of the CT manufactured in accordance with the present invention is not required to correspond substantially identically to the thickness of the master coil or strips cut from the master coil, fewer thicknesses of flat stock are needed to manufacture a full range of wall thicknesses in the CT. In the manufacturing process of CT according to the present invention, tubing exiting the tube mill is introduced into a forging process that substantially reduces the deliberately oversized OD of the coil tubing in process to the nominal or target OD and may reduce or increase the wall thickness of the CT produced. Because the wall thickness of the CT manufactured may be greater than, less than, or the same as, the thickness of the flat stock used to make the CT, a wide variety of tapered tubing may be manufactured from flat stock having a uniform thickness. This reduction in OD and adjustment to the wall thickness may take place by introducing the coil tubing in process to a hot reduction mill that subjects the entire tubing to forging. This forging to believed to improve the quality, strength, reliability, resistance to coiling and uncoiling stresses, chemical resistance and other physical properties of the CT, particularly in the locations of the strip-to-strip transverse welds and the longitudinal seam weld. Further, in some embodiments of the present invention, the speed in feet-per-minute of CT spooled onto the takeup reel is greater than the speed of flat stock entering the tube mill. This results in shorter production times for the manufacture of CT.

In certain embodiments, the grain structure of the steel forming the CT is improved and made more homogeneous so that the regions of the transverse weld and the longitudinal weld are substantially identical to the remainder of the CT. The occurrence of grain disturbance at the transverse weld is minimized or substantially eliminated. The interruption of the grain profile at the longitudinal seam weld of tubing is minimized or substantially eliminated. The speed of processing is increased to deliver to the takeup reel longer lengths of CT with improved resistance to coiling and uncoiling stresses.

Certain embodiments are not limited to any individual feature or object described herein. Rather, the embodiments include combinations of features and objects that distinguish from the prior art in structure, function, and process. Features of the invention have been broadly described so that the detailed description that follows may be better understood and so that the contributions to the art may be better appreciated. There are, of course, additional aspects of the invention described below that may be included in the subject matter of the claims. Those skilled in the art who have the benefit of this invention, its teachings and suggestions, will appreciate that the conceptions of this disclosure may be used as a creative basis for designing other structures, methods and systems for carrying out and practicing the present invention. The claims of this invention are intended to be read to include any legally equivalent apparatus or methods that do not depart from the spirit and scope of the present invention.

The present invention recognizes and addresses the noted problems of CT failures and long felt needs and provides a solution to those problems and a satisfactory meeting of those needs in its various possible embodiments and equivalents thereof. To one skilled in this art who has the benefit of this invention, its teachings, and suggestions, other purposes and advantages will be appreciated from the following description of preferred embodiments, provided for the purpose of disclosure, when taken in conjunction with the accompanying drawings. The detail in these descriptions is not intended to frustrate the inventor's objective to claim this invention no matter how others may later disguise it by variations in form or additions of further improvements. The present invention is intended to provide a new, useful, and non-obvious improvement to continuous CT together with new, useful, and nonobvious methods and processes for making such CT.

Features of the present invention have been broadly described so that the detailed description that follows may be better understood and in order that the contribution to the art may be better appreciated. There are, of course, additional aspects of the invention described below and which may be included in the subject matter of the claims to this invention.

### DESCRIPTION OF THE DRAWINGS

A more particular description of embodiments of this invention briefly summarized above may be had by reference to the embodiments that are shown in the drawings that form a part of this specification. These drawings illustrate certain preferred embodiments and are not to be used to improperly limit the scope of the invention which may have other equally effective or legally equivalent embodiments.

FIG. 1 is a schematic representation of a prior art system for producing coil tubing.

FIG. 2 is a schematic representation of a joining process of the present invention.

FIG. 3 depicts an alignment of the ends of strips to be joined.

FIG. 3A depicts an alterative for an alignment of the ends of the strips to be joined.

FIG. 3B depicts another alternative for an alignment of the ends of the strips to be joined.

FIG. 4 schematically depicts a welding process for joining two ends of strip stock.

FIG. 5 schematically depicts the welded ends of strip stock prior to finishing or dressing.

FIG. 6 schematically depicts grinding away a portion of the upset formed by a welding process used to join the end of the strips.

FIG. 7 schematically depicts rolling the transverse weld used to join the strips to help conform the geometry of that weld to the surrounding strip stock.

FIG. 8 depicts the transverse weld following finishing or dressing.

FIG. 9 schematically depicts heat treating the finished or dressed transverse weld.

FIG. 10 schematically depicts the flow of the strip stock through the joining station and then into a tube mill.

FIG. 11 schematically depicts some of the steps used in the practice of the present invention including the step of forging the tubing that exits from the tube mill.

FIG. 12 depicts relatively large diameter, thick walled tubing exiting the forging station of FIG. 11.

FIG. 13 depicts relatively small diameter, thin walled tubing exiting the forging station of FIG. 11.

FIG. 14 depicts relatively small diameter, thick walled tubing exiting the forging station of FIG. 11.

### DESCRIPTION OF EMBODIMENTS PREFERRED AT THE TIME OF FILING FOR THIS PATENT

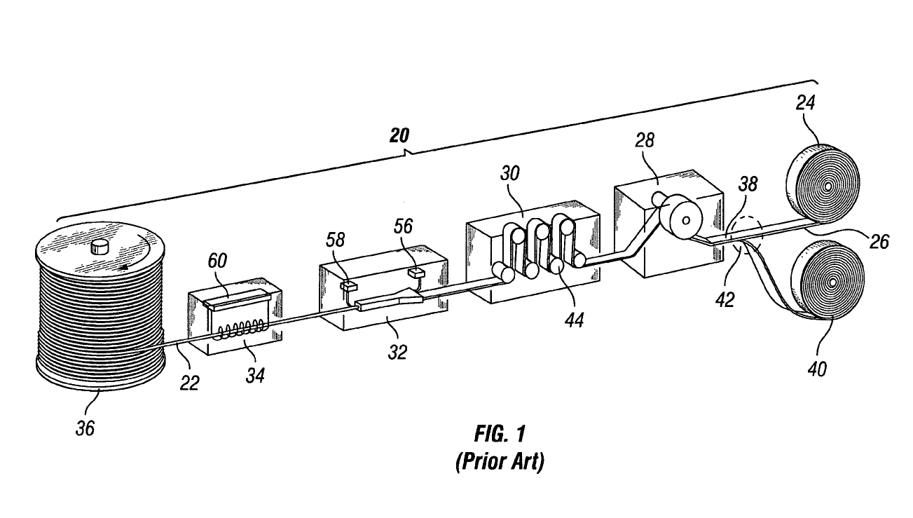

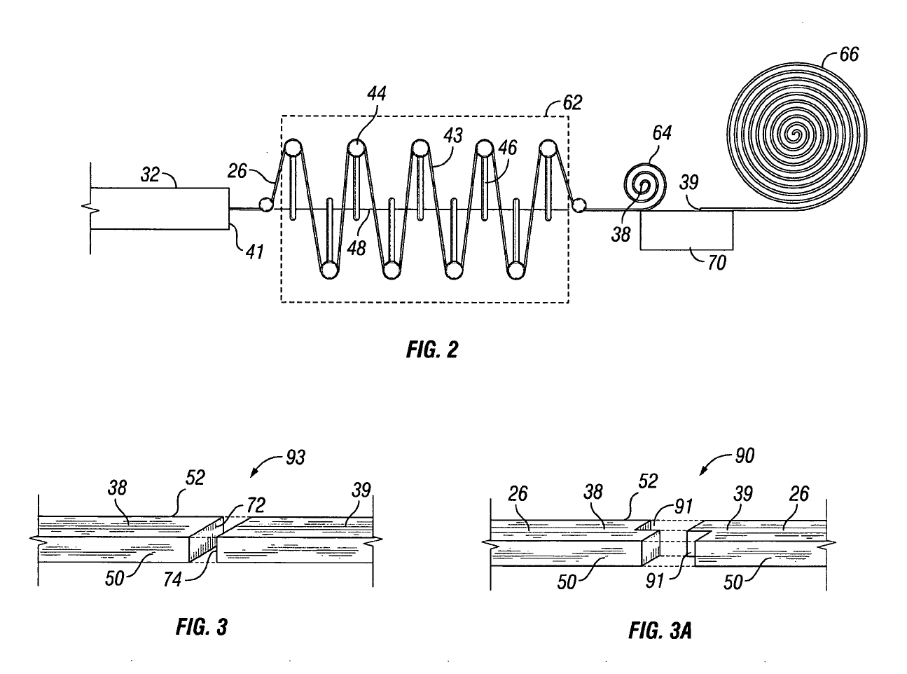

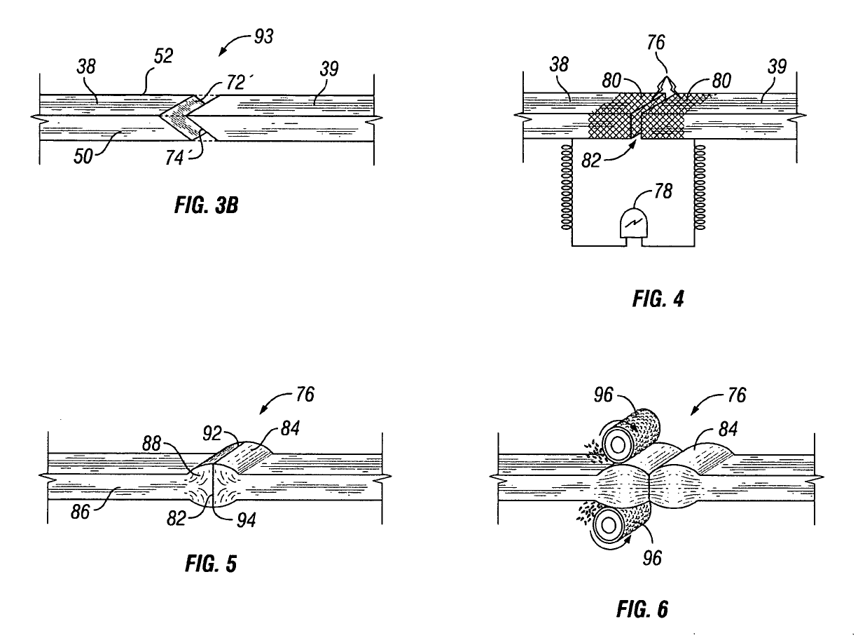

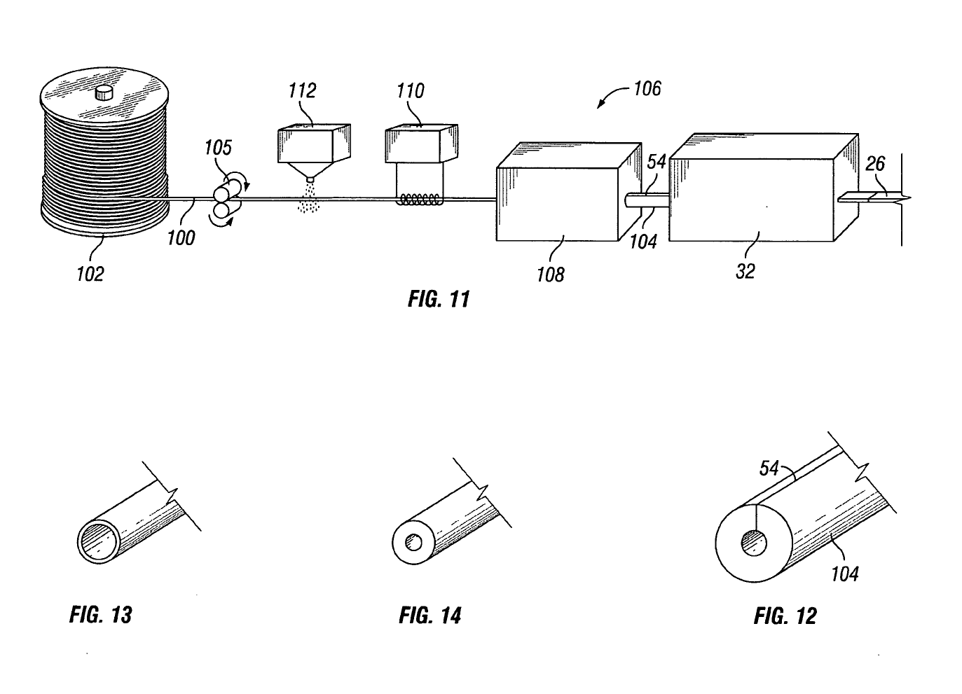

In the prior art system 20 as depicted in FIG. 1, a length of CT 22 could be made by the following process. A first feed coil 24 of flat strip stock 26 is fed to an accumulator 28, then through a conditioner 30 to remove some of the coiling stresses and help flatten the flat strip stock 26. Then the strip stock 26 is fed into a tube mill or tube former 32 following which the tubing is heat treated in a heat treater 34 and, following cooling, is spooled onto a takeup reel 36. The first feed coil 24 of flat stock 26 is fed through the system 20 until the trailing end 38 of the first feed coil 24 is reached. Thereafter, a second feed coil 40 is welded to the first feed coil 24 by means of a bias weld joint 42, and the process continues without interruption until a desired length of CT 22 has been spooled onto the takeup reel 36. The accumulator 28 is positioned so that the tube mill 32 continues to function and tubing made from the leading end and center section of the first feed coil continues to be spooled onto the takeup reel 36 while the trailing end 38 of the first feed coil 24 is stationary to enable the bias weld joint 42 to be formed. During that time the “slack” in the accumulator 28 provides the flow of material into the tube mill 32 while keeping the trailing end 38 of the first feed coil 24 stationary. This could provide sufficient time to make a weld joint such as a bias weld joint 42 and favorably position the second feed coil 40 for continuous operation. The accumulator 28 and conditioner 30 are now well known in the art. The conditioner 30 includes rollers 44 that are positioned in slots 46 (FIG. 2) that can move to a center line 48 (FIG. 2) of the flat stock feed path to provide flexibility in the delivery of material to the tube mill 32. The tube mill 32 operates to gradually urge the flat strip stock into the configuration of a tube. This occurs in stages through the use of rollers (not shown) and dies (not shown) and the like that urge or cam the flat stock 26 into a circular cross-section. This ultimately brings into proximity the left and right side edges 50, 52 respectively (FIG. 3) of the flat stock 26 to achieve a closure of the now formed circular cross-sectioned tubing, and a longitudinal seam weld 54 (FIG. 11) is made. This longitudinal seam weld 54 may be an electric resistance weld (“ERW”). An internal scarfing device 56 or other device may be used to reach into the inside of the tubing being longitudinally welded to remove excess internal weldment from the longitudinal weld. Similarly, an external scarfing device 58 or the like is used to remove excess external weldment from the longitudinal weld to dress the outside surface of the tubing. An induction heater 60 may be used to heat treat the tubing at a heat treater 34, and, following cooling, the CT 22 is spooled onto a takeup reel 36.

In the present invention there are some similarities to the known process. That is, as shown in FIG. 2 an accumulator 62 may be used stop the trailing end 38 of a first feed coil 64 in relation to the movement of the leading end 41 and center section 43 of the flat stock 26 through a tube former or tube mill 32. A conditioner 63 may serve to condition the flat stock 26 to improve the handling of the flat stock through the tube mill 32. When the trailing end 38 of the first feed coil 64 is reached, the accumulator 62 is activated to stop the movement of the trailing end 38 to facilitate joining of that trailing end 38 to the leading end 39 of a second feed coil 66 at a joining station 70. Typically both the trailing end 38 of the first feed coil 64 and the leading end 39 of the second feed coil 66 are cut and trimmed or “dressed” to facilitate joining. A variety of joining techniques may be used in the joining station 70 to join the end edge 72 of the trailing end 38 of the first feed coil 64 to the lead edge 74 of the leading end 39 of the second feed coil 66 (FIGS. 2 and 3.) In one preferred embodiment the trailing end 38 of the first feed coil is joined to the leading end 39 of the second feed coil by a process known as forge welding (FIGS. 3, 3A, 3B, 4 and 5.) A forged weld 76 utilizes some energy or power source 78 to create a localized zone of intense heat 80 at the interface or juncture 82 of the two lengths of stip stock. In one preferred embodiment as depicted in FIGS. 4 and 5 the two lengths of strip stock are urged toward each other after heating 80 has occurred to achieve the forged weld 76. This may result in there being a slight upset 84 of material at the interface 82 of the two lengths of strip stock. The axial grain 86 of the steel or steel alloy material comprising the strip stock is disturbed at the region of the forged weld 76. This may result in the grain turning upwardly to form what is known as “end grain” 88 at the forged weld at and around the juncture 82 of the two lengths of strip stock. The misalignment of the grain of the steel or steel alloy at this location 82 can impart some undesirable characteristics to the CT 22 thereafter fashioned from the flat strip stock 26. For example, it is believed that the end grain 88 is more vulnerable to corrosion or may not display the same physical or metallurgical characteristics of the remaining steel that enjoys a substantially coherent axial alignment as depicted by the axially coherent grain at 86.

The forged weld 76 that is achieved to join the lengths of strip stock may have the end edge 72 and lead edge 74 aligned with the side edges 50, 52 at substantially 90° to achieve a “butt weld” or may be at some angle other than 90° to achieve a “bias weld”. See U.S. Pat. Nos. 4,863,091 and 5,191,911, both in the name of the same inventor as the present invention, for examples of a bias weld. In addition to 90° butt welding or bias welding to join the trailing end 38 of the first reel to the leading end 39 of a second reel, a 90° offset weld 90 may be used (FIG. 3A). The 90° offset weld requires that a right-angled notch 91 be formed in both the trailing end 38 and leading end 39 of the strips to be jointed. Alternative geometries such as right-angled multiple notches (not shown), step notches (not shown), mortises (not shown), or t-slots (not shown) may be used. A further alternative is the 90° ramp weld 93 that utilizes a ramped end edge 72′ and a cooperating ramped lead edge 74′. (FIG. 3B) Both ramped edges 72′, 74′ are aligned with the side edges 50, 52 at substantially 90°. The 90° offset weld 90, the 90° ramp weld 93, and the other alternatives noted are alternative preferred embodiments, and may be achieved by using forge welding, plasma welding, laser welding, high frequency electric resistance welding (“HFERW”), TIG welding, or any other satisfactory welding technique.

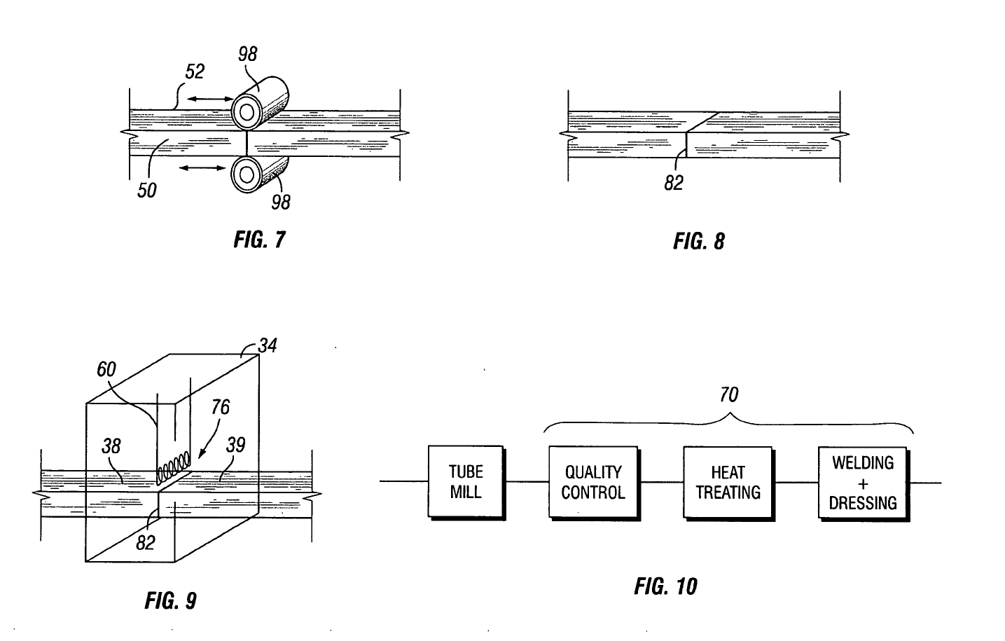

In any event, it is desirable to conform the geometry of the transverse weld to the surrounding material before transverse weld is introduced into the tube mill. That is, the upset 84 formed, whether by weldment or parent material, along the top 92 and bottom 94 of the interface 82 may be removed, for example, by grinding with grinders 96 (FIG. 6) and/or by rolling with rollers 98 (FIG. 7). Similar dressing may take place with respect to the left side edge 50 and the right side edge 52 of the composite strip formed as a result of the transverse weld. An objective in the practice of the present invention is to achieve a weld joint having a geometry that corresponds generally to the thickness and width of the surrounding flat strip stock 26. Dressing the weld joint helps achieve an uninterrupted flow of fluid through the CT and minimizes the likelihood of localized erosion or corrosion at the site of the transverse weld joint. The geometry should be conformed to the greatest extent feasible consistent with the time provided by the accumulator 62 to hold stationary the trailing end 38 of the first feed coil 64. A forged weld 76 and its following dressing steps can be accomplished at the joining station 70 within the time allotted.

In addition, heat treating by a heat treater 34 of the forged weld 76 may impart further favorable characteristics to the juncture 82 as schematically depicted in FIG. 9. The heat treating may be accomplished by induction heating by an induction heater 60 to raise the temperature of the composite welded strip at the location of the transverse weld to a temperature to achieve improved characteristics of the weld joint in terms of its chemistry, metallurgy, and physical profile.

The joining station 70 may include a quality control inspection step. The quality control inspection step may utilize x-rays, or ultrasound, or other non-destructive testing techniques known in the art for detecting flaws in welds. It is believed that the selection of a forged weld can result in a fast and relatively defect free joining of the trailing end 38 of the first feed coil 64 to the leading end 39 of a second feed coil 66. In alternative preferred embodiments, the transverse weld could be achieved by the use of forge welding, plasma welding, laser welding, HFERW, TIG welding, or any other satisfactory welding technique. Of course, similar joining steps may take place between subsequent feed coils, for example, between a second and a third feed coil (not shown), between a third and a fourth feed coil (not shown), and so on.

After the joining occurs between feed coils at joining station 70, the accumulator 62 and conditioner 63 may be operated to resume feed to the tube mill 32 of flat stock from the second feed coil 66. In this manner there is no interruption in the operation of the tube mill 32 during changeover of feed coils, and flat stock 26 is continuously fed to the tube mill 32 without having to stop the tube mill.

The tubing exiting from the tube mill 32 has as its circumference a dimension that is substantially the same as the width of the flat stock 26 fed into the tube mill. In addition, the tubing exiting from the tube mill 32 has as its wall thickness a dimension that is substantially the same as the thickness of the flat stock 26 fed into the tube mill. Within the tube mill, there are sizing rollers and other known arrangements (not shown) to conform the OD of the tubing being made to substantially circular cross-section. The sizing arrangements may include sizing rollers or stationary apertures or dies that serve to remove any irregularities in the outside dimension of the tubing that may be inherent in the flat feed stock 26 or that may have been introduced during processing.

In the present invention the width of the flat feed stock 26 is deliberately selected to be substantially greater than the circumference (and hence the OD) of the CT 100 spooled onto the takeup reel 102. That is, the tubing that exits the tube mill 32 is deliberately of a greater diameter than the target or nominal OD of the CT 100 of the present invention. In the present invention the thickness of the flat feed stock 26 may deliberately be selected to be substantially greater than, the same as, or substantially less than the wall thickness of the CT 100 spooled onto the takeup reel 102. That is, the tubing that exits the tube mill 32 may deliberately be of a greater, lesser, or the same wall thickness as the target or nominal wall thickness of the CT 100 of the present invention. The relatively large diameter tubing-in-process 104 that exits the tube mill 32 is introduced into a forging stage 106. This forging stage 106 may occur in a hot reduction mill 108 as shown in FIG. 11. The hot reduction mill 108 is an apparatus that heats the tubing-in-process 104 to a temperature where its OD is substantially reduced through the use of rollers and/or dies (not shown) that forge the tubing-in-process 104 as the OD, and perhaps the wall thickness, is adjusted. This action of heating and hot forging of the tubing-in-process 104 results in a favorable realignment of the end grain 88 in the region of the transverse weld that joined the trailing end 38 of the first feed coil 64 to the leading end 39 of the second feed coil 66. In addition, the forging action provides a beneficial realignment of the grain structure in the longitudinal seam weld 54 and in the regions therearound. In the forging process there is an elongation or stretching of the tubing-in-process 104 in its semi-plastic state. This may also result in the reducing of the wall thickness. This is accomplished through the use of drive rollers 105 in the hot reduction mill 108 or downstream of the hot reduction mill 108, sizing rollers (not shown), or dies (not shown) that introduce axial tension into the tubing-in-process 104 that increases the speed or velocity of its travel through this stage of the process. Therefore, in some embodiments of the present invention, the speed of the tubing that exits the forging stage or hot reducing mill is faster than the speed of the tubing-in-process 104 that enters the forging stage or hot reduction mill. The increase in speed of processing results in CT 100 being spooled onto the takeup reel 102 at a faster rate than the rate of feed of flat stock 26 from the feed coil. It is believed that a significant increase in processing speed may be accomplished when the teachings of the present invention are followed. In alternative preferred embodiments of the present invention, in the forging process there could be a compression of the tubing-in-process 104 in its semi-plastic state. This may also result in the increasing of the wall thickness as the OD is reduced. This could be accomplished through the use of drive rollers 105 in the hot reduction mill 108 or downstream of the hot reduction mill 108, sizing rollers (not shown), or dies (not shown) that introduce axial and radial compression into the tubing-in-process 104 that increases the wall thickness and reduces the OD of the CT exiting the forging stage or hot reducing mill.

The forged CT 100 exiting the forging stage or hot reducing mill may be further heated by a heater 110 and then quenched in a quenching bath 112 to achieve a quench-and-temper heat treatment. Selected portions of the CT may be subjected to quench-and-temper heat treatment during manufacture. This could result in a length of CT that has chemical, metallurgical, and physical characteristics along different portions. For example, one or both ends of the CT could be heat treated differently from the middle of the length of CT. Following a quench-and-temper heat treatment station 110, 112, the forged CT 100 may be spooled onto the takeup reel 102.

As depicted in FIGS. 12-14, in the forging process or hot reducing mill, the wall thickness “wt” and OD of the CT produced may have a variety of aspect ratios (ratio of outside diameter to inside diameter or ratio of outside diameter to wall thickness.) That is, not only will the OD of CT 100 produced be different from the OD of the tubing-in-process 104 exiting the tube mill 32, but also the wall thickness of the finished CT 100 may be the same as, greater than, or less than the wall thickness of the tubing-in-process 104 exiting the tube mill 32. Within the forging stage or hot reduction mill, the temperature, speed of drive, tension on the tubing-in-process 104, rate of OD reduction, and other wall thickness configuring parameters, may be adjusted to select wall thicknesses over a range in relation to the wall thickness of the tubing-in-process 104 exiting the tube mill 32 or the thickness of the flat stock 26. Changes may be made during the manufacture of a single length of CT to produce a product with a varied OD, wall thickness, and yield strength to address the specialized requirements of different uses for the CT to provide a level of customization not heretofore possible.

In the prior art when it was desired to change the OD of CT produced in a tube mill, the rollers and/or dies of the tube mill would be changed manually that resulted in substantial delays and expenditure of substantial labor to achieve the breakdown and turnover to prepare the mill for the manufacture of a CT of a different OD. With the present invention, no tear down of the mill is necessary. Rather, adjustments may be made to the system without having to replace rollers and the like and without the need for substantial labor to prepare the system for the manufacture of CT of a different OD. This flexibility facilities manufacturing changes while the CT forming process is taking place.

For example, if it is desired to manufacture CT having a varying OD, this may be accomplished using the manufacturing process of the present invention. Such tubing might have a continuous or a varying wall thickness. That is, CT could be manufactured having a constant wall thickness but a varying OD using the present invention. Alternatively, CT could be manufactured having both a varying OD and a varying wall thickness.

If it is desired to manufacture CT having different yield strengths, the quench-and-temper station may be selectively included in the process. This facilitates making a continuous length of CT that has a varying yield strength for applications where this would provide operational and economic benefits.

Therefore, it may be observed to a person of skill in the art that the present invention and the embodiments disclosed herein and those covered by the appended claims are appropriate to carry out the objectives and to demonstrate the features set forth above. Certain alterations may be made in the subject matter without departing from the spirit and the scope of this invention. It is realized that changes are possible within the scope of this invention, and it is intended that each element or step recited in any of the following claims is to be understood as referring to all equivalents or steps. The following claims are intended to cover the invention as broadly as legally possible in whatever form it may be utilized. The invention claimed herein is new in accordance with 35 U.S.C. §102 and satisfies the conditions for patentability in §102. The invention claimed herein is not obvious in accordance with the standards set forth in 35 U.S.C. §103 and satisfies the conditions for patentability in §103. The specification and the claims that follow are in accordance with the requirements of 35 U.S.C. §112. The inventor may rely on the Doctrine of Equivalents to determine and assess the scope of the invention and of the claims that follow as they may pertain to methods and apparatus not materially departing from, but outside the literal scope of, the invention as set forth in the following claims.

What is claimed is:

1. A continuous length of coil tubing having a means to withstand repeated coiling and uncoiling stresses, said coil tubing being made by:
trimming a trailing end of a first length of flat strip stock having a first leading end and a first trailing end and a first center section and further having a first width and a first thickness, trimming a leading end of a second length of flat strip stock having a second leading end and a second trailing end and a second center section and further having a second width and a second thickness substantially the same as the first width and first thickness of said first length of flat strip stock;
while advancing the first leading end and first center section of said first length of flat strip stock at a first rate of feed speed in a tube forming process, stopping the first trailing end of said first length of flat strip stock;
transversely welding the second leading end of said second length of flat strip stock to the stopped first trailing end of said first length flat strip stock to form a composite strip;
while advancing the first leading end and first center section of said first length of flat strip stock at a first rate of feed speed in a tube forming process, stopping the first trailing end of said first length of flat stock and finishing the composite strip by conforming the transverse weld to the width and thickness of the first and second flat strip stock;
forming the finished composite strip into tubing-in-process having a first outside diameter and a first wall thickness by welding opposing edges of the composite strip to form a longitudinal weld;
introducing the tubing-in-process into a hot reduction mill at the first feed speed;
reducing the outside diameter of the tubing-in-process to a second outside diameter less than the first outside diameter;
hot forging the tubing-in-process to realign the grain structure of the tubing-in-process at the location of the transverse weld and the longitudinal weld to alter the grain structure of the longitudinal weld and the end weld to a grain structure more like the grain structure of the tubing-in-process having the second outside diameter;
withdrawing tubing from the hot reduction mill at a second feed speed different from the first feed speed.

2. The coil tubing of claim 1 wherein the wall thickness of the tubing withdrawn from the hot reduction mill is less than said first wall thickness.

3. The coil tubing of claim 1 wherein the wall thickness of the tubing withdrawn from the hot reduction mill is the same as said first wall thickness.

4. The coil tubing of claim 1 wherein the wall thickness of the tubing withdrawn from the hot reduction mill is greater than said first wall thickness.

5. The coil tubing of claim 1 wherein the transverse weld is made using at least one of the following forms of welding: forge welding, plasma welding, laser welding, HFERW, or TIG welding.

6. The coil tubing of claim 1 wherein the transverse weld is a 90 degree butt weld.

7. The coil tubing of claim 1 wherein the transverse weld is a 90 degree offset weld.

8. The coil tubing of claim 1 wherein the transverse weld is a 90 degree ramp weld.

9. The coil tubing of claim 1 wherein at least some of the tubing withdrawn from the hot reduction mill is quench and tempered.

10. The coil tubing of claim 1 wherein the second rate of feed speed of withdrawing the tubing from the hot reduction mill is constant.

11. The coil tubing of claim 1 wherein the second rate of feed speed of withdrawing the tubing from the hot reduction mill varies over the length of coil tubing.

12. The coil tubing of claim 1 wherein the second rate of feed speed of withdrawing the tubing from the hot reduction mill is less than the first rate of speed.

13. The coil tubing of claim 1 wherein the second rate of feed speed of withdrawing the tubing from the hot reduction mill is greater than the first rate of speed.

14. The coil tubing of claim 1 wherein the tubing includes a substantially smooth internal wall surface at the locations of the longitudinal weld and the transverse weld.

15. The coil tubing of claim 1 and further including the step of inspecting the transverse weld with a non-destructive inspection test to confirm the integrity of the weld.

16. A continuous length of coil tubing comprising:
a spool for carrying a length of coil tubing;
a length of coil tubing coiled on said spool;
a means to withstand repeated coiling and uncoiling stresses in said length of coil tubing, said means comprising:
a first length of flat strip stock having a width and a thickness dimension and having edges, flat surfaces, and a trailing end;
a second length of flat strip stock having a width and a thickness dimension substantially the same as that of said first length of flat strip stock and having edges, flat surfaces, and a leading end;
an end weld between said trailing end and said leading end of said first and second lengths of flat strip stock respectively, said end weld joining said first and said second lengths to form a composite strip;
a longitudinal weld joining the edges of the first and second strips to form tubing having a first outside diameter; and
means to change the outside diameter of the tubing from said first outside diameter to a second outside diameter less than said first outside diameter and to alter the grain structure of the longitudinal weld and the end weld to a grain structure more like the grain structure of tubing having said second outside diameter.

17. The coil tubing of claim 16 wherein the means to change the outside diameter of the tubing further includes means to reduce the wall thickness of the coil tubing.

18. The coil tubing of claim 16 wherein the means to change the outside diameter of the tubing further includes means to maintain the same wall thickness of the coil tubing.

19. The coil tubing of claim 16 wherein the means to change the outside diameter of the tubing further includes means to increase the wall thickness of the coil tubing.

20. The coil tubing of claim 14 wherein the end weld is made using at least one of the following forms of welding: forge welding, plasma welding, laser welding, HFERW, or TIG welding.

21. The coil tubing of claim 14 wherein the end weld is a 90 degree butt weld.

22. The coil tubing of claim 14 wherein the end weld is a 90 degree offset weld.

23. The coil tubing of claim 14 wherein the end weld is a 90 degree ramp weld.

24. The coil tubing of claim 14 wherein at least some of the tubing withdrawn from the means to change the outside diameter and alter the grain structure is quench and tempered.

25. The coil tubing of claim 14 and further including means for withdrawing at a constant rate of speed the tubing from the means to change the outside diameter and alter the grain structure.

26. The coil tubing of claim 14 and further including means for withdrawing at a variable rate of speed the tubing from the means to change the outside diameter and alter the grain structure.

27. The coil tubing of claim 14 and further including means for forming a substantially smooth internal wall surface at the locations of the longitudinal weld and the end weld.

28. The coil tubing of claim 14 and further including means for inspecting the end weld with a non-destructive inspection test to confirm the integrity of the weld.

29. A method of making continuous length of coil tubing, said method comprising:
trimming a trailing end of a first length of flat strip stock and a leading end of a second length of flat strip stock, the first length of flat strip stock having a leading end and a trailing end and a center section and further having a width and a thickness, the second length of flat strip stock having a leading end and a trailing end and a center section and further having a width and a thickness that are substantially the same as the width and thickness the first length of flat strip stock;
welding the leading end of said second length of flat strip stock to the trailing end of said first length flat strip stock to form a composite strip transverse weld;
feeding the finished composite strip into a tube forming process to form tubing having a first outside diameter and a first wall thickness by welding opposing edges of the composite strip to form a longitudinal weld;
introducing the tubing coming out of the tube forming process into a hot reduction mill at a first feed speed;
reducing the outside diameter of the tubing to a second outside diameter less than the first outside diameter;
hot forging the tubing to realign the grain structure of the welds to a grain structure more like the grain structure of the tubing having the second outside diameter; and
withdrawing the tubing from the hot reduction mill at a second feed speed greater than said first feed speed.

30. The method of claim 29 wherein the tubing withdrawn from the withdrawing step has a second wall thickness less than the first wall thickness.

31. The method of claim 29 wherein the tubing withdrawn from the withdrawing step has a second wall thickness substantially the same as the first wall thickness.

32. The method of claim 29 wherein the tubing withdrawn from the withdrawing step has a second wall thickness greater than the first wall thickness.

33. The method of claim 29 wherein the welding to form the transverse weld includes at least one of the following forms of welding: forge welding, plasma welding, laser welding, HFERW, or TIG welding.

34. The method of claim 29 wherein the welding to form the transverse weld includes a 90 degree butt weld.

35. The method of claim 29 wherein the welding to form the transverse weld includes a 90 degree offset weld.

36. The method of claim 29 wherein the welding to form the transverse weld includes a 90 degree ramp weld.

37. The method of claim 29 and further including the step of quench-and-temper heat treating at least some of the coil tubing.

38. The method of claim 29 and further including the step of withdrawing at a constant rate of speed the tubing from the withdrawing means.

39. The method of claim 29 and further including the step of withdrawing at a variable rate of speed the tubing from the withdrawing means.

40. The method of claim 29 and further including the step of forming a substantially smooth internal wall surface at the locations of the longitudinal weld and the end weld.

41. The method of claim 29 and further including the step of inspecting the transverse weld with a non-destructive inspection test to confirm the integrity of the weld.
